(19) United States
(12) Patent Application Publication
(10) Pub. No.: US 2010/0043784 A1
(43) Pub. Date: Feb. 25, 2010

(54) TREATMENT OF SUGAR JUICE

(76) Inventor: Craig Robert Carl Jensen, Umdloti Beach (ZA)

Correspondence Address: BRINKS HOFER GILSON & LIONE, P.O. BOX 10395, CHICAGO, IL, 60610, US

(21) Appl. No.: 12/312,314

(22) PCT Filed: Nov. 8, 2007
(86) PCT No.: PCT/IB2007/054534

§ 371 Date: May 5, 2009

(30) Foreign Application Priority Data
Nov. 8, 2006 (ZA) 2006/09300

(51) Int. Cl. C13J 1/06

(52) U.S. Cl. 127/46.2

(57) ABSTRACT

A process for treating clarified sugar cane juice includes subjecting, in a first treatment stage, the juice to purification to remove particles larger than about 0.1 micron. The clarified sugar juice then passes through a primary ion exchange stage in which it is sequentially brought into contact with at least one strong acid cation ion exchange resin in the hydrogen form and thereafter with at least one weak base anion ion exchange resin in the hydroxide form, to effect primary demineralization of the sugar juice. Thereafter the sugar juice is passed through a secondary ion exchange stage in which it is sequentially brought into contact with at least one strong base anion ion exchange resin in the hydroxide form and thereafter with at least one acid cation ion exchange resin, to effect secondary demineralization of the sugar juice. Sugar products are recovered from the resultant purified sugar solution.

THIS INVENTION relates to the treatment of sugar juice. It relates in particular to a process for treating clarified sugar cane juice.

According to the invention, there is provided a process for treating clarified sugar cane juice, which process includes
subjecting, in a first treatment stage, clarified sugar cane juice to purification to remove particles larger than about 0.1 micron;
passing the clarified sugar juice from the first treatment stage through a primary ion exchange stage in which the sugar juice is sequentially brought into contact with at least one strong acid cation ion exchange resin in the hydrogen form and thereafter with at least one weak base anion ion exchange resin in the hydroxide form, to effect primary demineralization of the sugar juice;
thereafter passing the sugar juice through a secondary ion exchange stage in which the sugar juice is sequentially brought into contact with at least one strong base anion ion exchange resin in the hydroxide form and thereafter with at least one acid cation ion exchange resin, to effect secondary demineralization of the sugar juice, thereby to obtain a purified sugar solution; and
recovering sugar products from the purified sugar solution.

The clarified sugar cane juice that is the feedstock to the first treatment stage, is typically that obtained by preparing sugar cane stalks, e.g. disintegrating or breaking up the stalks; removing sugar juice from the prepared stalks by diffusion and/or milling, using imbibition water, thereby to obtain mixed juice; heating and liming the mixed juice; and subjecting the mixed juice to primary clarification, to obtain the clarified sugar cane juice. Instead, however, the clarified sugar cane juice which is used as feedstock to the first treatment stage, can be obtained by any other suitable preparation process.

In the first treatment stage, which can effectively be deemed to be a second clarification stage, sufficient suspended solids, organic non-sugar impurities and colour are removed to render the sugar juice amenable to subsequent treatment in the ion exchange stages.

The purification in the first treatment stage may be effected by means of filtration. The filtration may be effected by passing the clarified sugar juice through a membrane capable of removing particles larger than about 0.1 micron. More specifically, the sugar juice may be passed through a membrane in the size range 200 Angstrom to 0.1 micron. The clarified sugar juice is thus thereby subjected to ultrafiltration. The Applicant has found that ultrafiltration prior to ion exchange is important in order to inhibit rapid fouling of the ion exchange resins, and to ensure that the resultant sugar products meet required turbidity specifications.

The clarified sugar cane juice as obtained from sugar cane stalks as herein before described, has a low sugar or sucrose concentration, typically less than 15% (m/m), for example in the order of 10% to 15% (m/m). This low concentration sugar juice is suitable as a feedstock for the process of the present invention; however, it may be advantageous to use a higher concentration of sugar juice as feedstock, for example to reduce the cost of capital equipment required to treat the same amount of sugar or sucrose.

Thus, the process may include concentrating, for example, by means of evaporation, the clarified sugar juice before it enters the first treatment stage. It may thus be concentrated to a sugar or sucrose concentration of at least 20% (m/m), preferably from 20% to 40% (m/m) typically about 25% (m/m).

The clarified sugar cane juice is typically at an elevated temperature, e.g. at a temperature above 90° C. Thus, the treatment in the first treatment stage will normally also be effected at an elevated temperature; however, since ion exchange normally takes place at lower temperatures, e.g. at a temperature below 60° C., such as at about 10° C., the juice will normally be cooled down before ion exchange.

Low feedstock temperatures are also required during ion exchange to inhibit sucrose inversion to fructose and glucose, which can be catalyzed by strong acid cation resins. Thus, the filtered sugar juice from the first treatment stage will in any event be cooled to below 25° C. if no inversion from sucrose to fructose and glucose is required. Should inversion be required, the degree of inversion can be controlled by adjusting the temperature of the sugar juice before it enters the primary ion exchange stage. Thus, by reducing the sugar juice temperature to about 10° C., e.g. by using a refrigeration stage, minimal sucrose inversion to fructose and glucose will take place in the ion exchange stages.

In the primary ion exchange stage, the sugar juice is initially preferably brought into contact sequentially with two of the strong acid cation ion exchange resins in the hydrogen form, which are thus arranged in series, and thereafter into contact with the weak base anion ion exchange resin in the hydroxide form. The weak base anion ion exchange resin acts to neutralize the juice. Although an acrylic resin can be used for the weak base anion ion exchange resin, a styrenic resin is preferably used since it removes organic matter more efficiently than does an acrylic resin. The juice may thereafter, in the primary ion exchange stage, then be passed through a further strong acid cation ion exchange resin in the hydrogen form, and thereafter sequentially through two weak base anion ion exchange resins in the hydroxide form, which are thus also arranged in series. The first of these resins will act to neutralise the juice whereas the second will effect further decolourization of the juice.

It is believed that in excess of 95% of the feed ash and up to 70% of the juice colour will be removed in the primary ion exchange stage. Furthermore, simultaneous de-ashing or demineralization and inversion can be achieved in the primary ion exchange stage, with inversion, if required, being controlled by controlling the temperature of the feed juice entering the ion exchange stage as herein before described.

The process may include regenerating the resins of the primary ion exchange stage from time to time, as required. Thus, the strong acid cation ion resin may be regenerated by contacting it with a strong acid such as hydrochloric or nitric acid, with a spent acid stream rich in potassium salt thereby being obtained. This stream is suitable for use as a fertilizer feedstock. The anion resins may be regenerated by contacting them with a suitable alkali such as an ammonium based alkali e.g. ammonium hydroxide. In this fashion, a spent alkali stream rich in nitrogen is obtained which is also suitable for use as a fertilizer feedstock.

In the secondary ion exchange stage, the sugar juice from the primary ion exchange stage may be brought sequentially into contact with two of the strong base anion ion exchange resins in the hydroxide form, which are thus arranged in series, before being brought into contact with the cation ion exchange resin. Instead, however, the sugar juice from the primary ion exchange stage may, in another embodiment of the invention, be brought into contact with a first strong base anion ion exchange resin in hydroxide form, then into contact with the cation ion exchange resin, and thereafter into contact with a second strong base anion ion exchange resin in the hydroxide form. The cation ion exchange resin may be either a strong or weak acid resin.

The process may also include regenerating the resins of the secondary ion exchange stage, from time to time as required. Thus, the strong base anion ion exchange resin may be subjected to a two stage regeneration process comprising firstly regenerating it using brine at a temperature above 50° C., and thereafter regenerating it with sodium hydroxide at a temperature below 50° C. The acid resin may also be regenerated using a strong acid. The mineral rich spent regenerants may also be used as fertilizer feedstocks.

The recovery of the sugar products from the purified sugar solution emerging from the secondary ion exchange stage may include, in a concentration stage, concentrating the purified sugar solution, eg to above 60% by mass dissolved solids. The resultant concentrated sugar juice may then be treated to recover therefrom at least one liquid sugar product and/or at least one solid or crystal sugar product.

If necessary, the sugar composition of the concentrated sugar juice or sugar solution may be adjusted.

As hereinbefore described, the sucrose/invert (fructose and glucose) ratio may be adjusted by adjusting the temperature at which the clarified sugar juice is subjected to ion exchange in the primary and secondary ion exchange stages.

To enhance, eg to maximise, fructose and glucose production, the temperature will thus be selected so that a high degree of inversion to fructose and glucose takes place in the primary and secondary ion exchange stages. To adjust the relative proportions of fructose and glucose independently, fully inverted concentrated sugar juice from the concentration stage may be routed to a fructose/glucose chromatographic separation stage. It may also be necessary to employ a chromatographic separation stage to separate either fructose or glucose from the liquid sugar product.

A plurality of liquid sugar products may be produced. Separate liquid product streams containing sucrose, fructose and glucose can then be blended or treated further separately e.g. using chromatographic technology and/or isomerization, to obtain liquid sugar products having desired compositions.

Thus, to adjust or vary the relative proportions of sucrose, fructose and glucose in the sugar products, the concentrated sugar juice or syrup may be subjected to chromatography and/or to isomerization.

If desired, the syrup or concentrated sugar juice from the concentration stage may pass to a polishing stage to improve product quality further. The polishing stage may comprise additional demineralization, e.g. using a mixed bed ion exchange resin, activated carbon adsorption or synthetic materials adsorption.

If it is desired to obtain solid or crystal sugar products, crystallization may be applied to any of the liquid streams.

The process may include subjecting the liquid sugar product to transformation, to obtain therefrom microcrystalline or amorphous sugar. The transformation of the liquid sugar product may include subjecting the liquid sugar product to a shear force to induce catastrophic sugar nucleation, and allowing the sugar product to crystallize, to form the microcrystalline or amorphous sugar.

The primary and secondary ion exchange stages as well as the chromatographic stages, may be carried out using a simulated using bed arrangement or system, e.g. by using a continuous fluid solid contacting apparatus such as that described in U.S. Pat. No. 5,676,826 (Rossiter et al), by a separation trained system such as that described in U.S. Pat. No. 5,122,275 (Rasche), by using a rotary distribution apparatus such as that described in WO 2004/029490 (Jensen et al), or the like.

The invention will now be described by way of example with reference to the accompanying drawings.

In the drawings

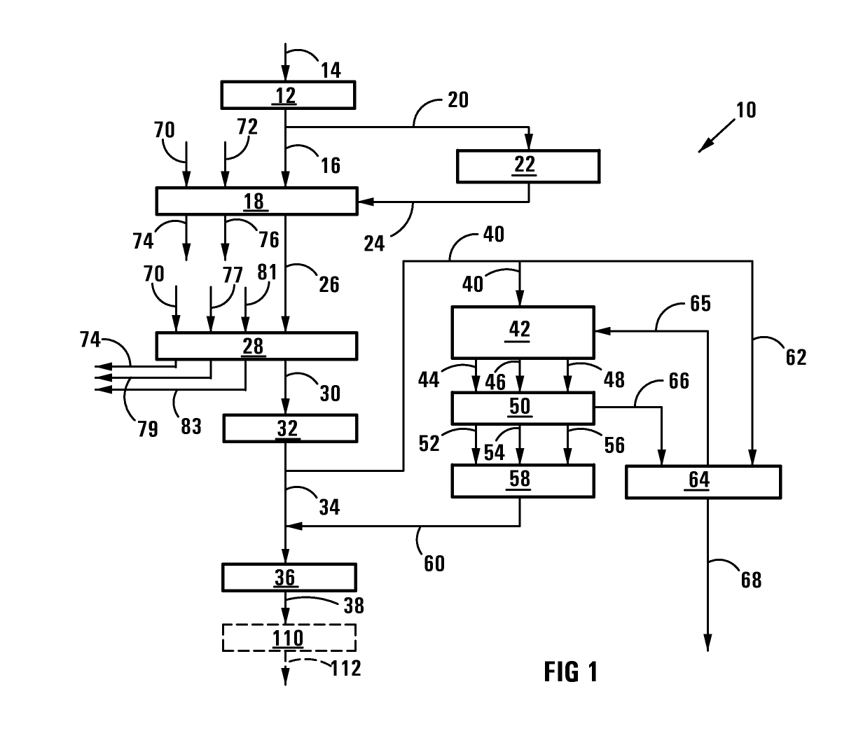

FIG. 1 shows a flow diagram of a process according to the invention for treating clarified sugar cane juice; and

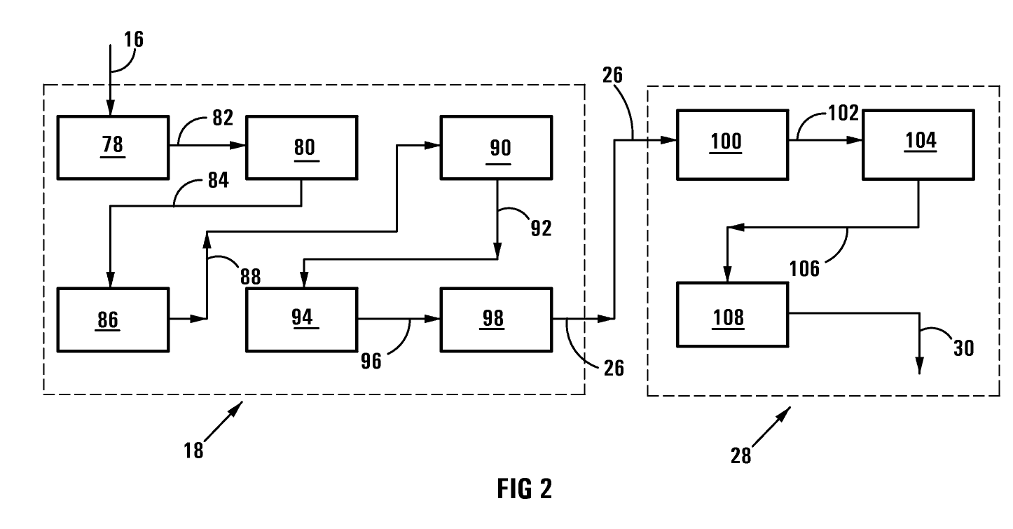

FIG. 2 shows the primary and secondary ion exchange stages of FIG. 1, in more detail.

In the drawings, reference numeral 10 generally indicates a process according to the invention for treating a clarified sugar cane juice.

The process 10 includes a first treatment or ultra-filtration stage 12, with a clarified sugar cane juice line 14 leading into the stage 12.

A transfer line 16 leads from the stage 12 to a primary ion exchange stage 18.

A line 20 leads from the line 16 to a refrigeration stage 22 with a line 24 leading from the refrigeration stage to the primary ion exchange stage 18.

A line 26 leads from the primary ion exchange stage 18 to a secondary ion exchange stage 28.

A transfer line 30 leads from the secondary ion exchange stage 28 to an evaporation stage 32.

A syrup withdrawal line 34 leads from the evaporation stage 32 to a polishing stage 36, with a liquid product withdrawal line 38 leading from the polishing stage 36.

A line 40 leads from the line 34 to a chromatography/isomerization stage 42, with fructose, glucose and sucrose withdrawal lines 44, 46 and 48 leading from the stage 42 to a storage stage 50. Fructose, glucose and sucrose lines 52, 54 and 56 respectively lead from the storage stage 50 to a blending stage 58, with a line 60 leading from the stage 58 to the line 34.

A line 62 leads from the line 40 to a crystallization stage 64 as does a line 66 which leads from the stage 50. A crystal product withdraw line 68 leads from the stage 64.

An acid feed line 70 leads into the primary ion exchange stage 18 as does an alkali feed line 72, with a spent acid line 74 and a spent alkali line 76 leading from the primary ion exchange stage 18.

The lines 74 and 76 lead to a fertilizer production stage (not shown).

The primary ion exchange stage 18 comprises first and second cation ion exchangers 78, 80, arranged in series, with a line 82 thus connecting these exchangers. From the exchanger 80 a line 84 leads to a first anion ion exchanger 86 with a line 88 leading from the exchanger 86 to a cation ion exchanger 90. A line 92 leads from the exchanger 90 to an anion ion exchanger 94, with a line 96 leading from the exchanger 94 to another anion ion exchanger 98. The line 26 leads from the exchanger 98.

Each of the cation ion exchangers 78, 80 and 90 comprises a strong acid cation ion exchange resin in the hydrogen form. Each of the anion ion exchangers 86, 94 and 98 comprises a weak base anion ion exchange resin in the hydroxide form.

The secondary ion exchange stage 28 comprises a strong base anion exchanger 100, with the line 26 leading to the exchanger 100. A line 102 leads from the exchanger 100 to another strong base anion exchanger 104. A line 106 leads from the exchanger 104 to a weak acid cation exchanger 108. The line 30 leads from the exchanger 108.

Each of the strong based anion exchangers 100, 104 contains a strong base anion ion exchange resin in the hydroxide form, while the weak acid cation exchanger 108 contains a weak acid ion exchange resin in the hydrogen form.

In use, a clarified sugar cane juice is prepared as hereinbefore described, i.e. by disintegrating and breaking up sugar cane stalks, extracting cane juice from the disintegrated stalks in a diffuser stage by means of imbibition water, heating and liming the mixed juice from the diffuser stage, and subjecting the thus treated juice to primary clarification, typically in a gravity settler, with the clarified sugar cane juice thus being withdrawn from the gravity settler.

The clarified sugar cane juices passes along the line 14 into the ultrafiltration stage 12 where it is subjected to ultrafiltration by passing it through a membrane having a specification range of 200 Angstrom to 0.1 micron. Thus, suspended solids, organic non-sugar impurities and some colour are removed from the clarified sugar cane juice by means of ultrafiltration in the stage 12.

If desired, the clarified sugar cane juice, before entering the ultrafiltration stage 12, can be subjected to concentration, e.g. by means of evaporation, to increase the sugar or sucrose concentration thereof from 10% to 15% (m/m) to 20% to 40% (m/m).

The clarified sugar cane juice passes from the ultrafiltration stage 12 to the primary ion exchange stage 18, optionally with cooling of at least a portion thereof, by means of the line 20, the refrigeration stage 22 and the line 24, depending on the degree of inversion required as herein before discussed. In other words, should inversion of sucrose to fructose and glucose be required, the degree of conversion will be controlled by adjusting the temperature of the juice that enters the primary ion exchange stage 18.

In the primary ion exchange stage 18 the juice passes sequentially through the cation ion exchanger 78, the cation ion exchanger 80, the anion ion exchanger 86, the cation ion exchanger 90, the anion ion exchanger 94 and the anion ion exchanger 98. In this fashion, in excess of 95% of the feed ash and up to 70% of the juice colour are removed during the primary demineralization which is effected in the stage 18.

It is believed that the use of the two. strong acid cation exchangers 78, 80 in series optimizes resin loadings, leading to a more efficient process.

The resin in the anion ion exchanger 86 is preferably a styrenic resin, and is used to neutralise the juice.

The use of the anion ion exchangers 94, 98 is beneficial since the exchanger 94 serves to neutralise the juice, while further decolourization of the juice is effected in the exchanger 98.

Thus, simultaneous de-ashing and inversion is achieved in the primary ion exchange stage 18, with inversion being controlled by controlling the temperature of the juice entering this stage.

Juice passes from the primary ion exchange stage 18, along the line 26, to the secondary ion exchange stage 28. In the secondary ion exchange stage 28, the juice is treated sequentially in the strong base anion exchanger 100, the strong base anion exchanger 104 and the weak acid cation exchanger 108. The use of two strong base anion exchangers in series results in further demineralization and decolourization, and maximises resin loadings, thereby leading to a more efficient process. The weak acid cation exchanger 108 serves to neutralize the juice.

The thus treated juice passes along the line 30 into the evaporation stage 30 where it is concentrated to a dissolved solids content is in excess of 60%.

The juice or syrup exiting the stage 32 typically has the following specification:
combined sucrose, fructose and glucose purity >95%
a total sugar purity >99%
juice colour <100 ICUMSA units
ash <0.1% (1000 ppm)

If it is desired to produce a general liquid sugar product, then the syrup or concentrated juice from the evaporation stage 32 passes along the line 34 to the polishing stage 36 where it is subjected to additional demineralization, e.g. by means of a mixed bed ion exchanger, activated carbon adsorption or synthetic material adsorption to improve product quality further. The liquid sugar product exiting the polishing stage 36 along the line 38 typically has the following specification: colour <40 ICUMSA units, ash <300 ppm.

To adjust or vary the relative proportions of sucrose, fructose and glucose in the syrup or concentrated juice emerging from the evaporation stage 32, the syrup can pass along the line 40 into the chromatography and/or isomerization stage 42. In the stage 42, specific sugars that is sucrose, fructose and/or glucose can be isolated and/or concentrated by means of chromatography and/or isomerization, so that, in the blending stage 58, a product having a desired sugar make up can be obtained.

To adjust the sugar composition, the sucrose/invert (fructose and glucose) ratio may firstly be adjusted by changing the juice temperature using the refrigeration stage 22, as hereinbefore described. By “invert” is meant a 50-50 (m/m) mixture of fructose and glucose. By means of this flexibility, the make up of the syrup emerging from the evaporation stage 32 can thus readily be adjusted from either a high sucrose product to a high invert product or one having a balance of sucrose and invert products.

However, to adjust the proportion of fructose and glucose independently, it is necessary to subject a fully inverted syrup emerging from the evaporation stage 32 to fructose/glucose chromatographic separation in the stage 42. Should sucrose be required in the final product, it will then be necessary to blend the chromatographic product with uninverted syrup (not shown).

It is also necessary to employ, in the stage 42, a chromatographic separation in order to completely separate the fructose, glucose or sucrose before blending the required liquid sugar product.

The product from the blending stage 58 can thus be blended further with the syrup from the evaporation stage 32 by means of a line 60.

Alternatively, to obtain a solid or crystal sugar product, the syrup from the evaporation stage 32 or the individual products from the stage 42 can be subject to crystallization in the stage 64. Crystallization can be applied to any of the liquid streams that are of sufficiently high purity of the particular sugar to allow crystallization to be carried out, e.g.
sucrose >90%
fructose >96%
glucose >90%

Examples of liquid sugar products that can be obtained from the stage 36 are high sucrose liquid sugar (sucrose greater than 90%; invert less than 5%), partially inverted sugar (invert 10% to 90%), fully inverted sugar (invert greater than 95%) (all percentages on a mass basis) and customized liquid sugar products, that is, any desired ratio of fructose, glucose and sucrose. In the event of the latter, it will be necessary to employ chromatography, i.e. to use the stage 42 to purify individual sugars, followed by blending of the purified products in the stage 58.

From time to time it will be necessary to regenerate the resins in the exchangers of the primary ion exchange stage 18. The cation resins are regenerated using nitric acid which enters through the line 70 with the spent acid, which is thus rich in minerals, being withdrawn along the line 74. The anion ion exchange resins in the stage 18 will be regenerated by means of ammonium hydroxide with spent ammonium nitrate, also rich in minerals, being withdrawn along the line 76. These effluents are blended to form ammonium nitrate.

Similarly, in the secondary ion exchange stage 28, the weak acid cation resin can be regenerated using nitric acid or any other weak acid. However, the strong base anion exchange resins in the stage 28 will be subjected to a two stage regeneration process comprising, in a first step, colour regeneration using brine, that is, sodium chloride solution at a temperature above 50° with the brine entering along a line 77, and spent brine being withdrawn along a line 79. The resin is then washed with water to cool it down to below 50° C. Thereafter, in a second stage, regeneration of active sites of the resin is effected by means of sodium hydroxide entering along a line 81 with the sodium hydroxide being at a temperature below 50°. Spent caustic is withdrawn along a line 83.

The spent regenerant streams withdrawn along the lines 74, 76, 79 and 83 can be blended (not shown) so as to provide a combined liquid stream that is suitable for use as a fertilizer since it is rich in minerals. This is only possible if potassium hydroxide or potassium chloride has been used for regeneration.

If sodium hydroxide or sodium chloride is used for regeneration, then the spent regenerant must be pumped to waste or to a recycling/recovery step.

Strong base resins are thermally sensitive, particularly in the OH form. It is believed that using the regeneration procedure herein before described, that is, where regeneration is first effected using hot brine, followed by rinsing off residual hot brine resin using water which also serves to cool down the resin and thereafter employing the caustic regeneration, minimizes competition between OH and Cl for resin sites and maximises resin life.

The ion exchange stages as well as the chromatographic steps, can be carried out using simulating moving bed technology. For this purpose, a continuous fluid solid contacting apparatus such as that described in U.S. 5,676,826 (Rossiter), a separation crane system such as that described in U.S. 5,122,275 (Rasche) or a rotary distribution apparatus such as that described in WO 2004/029490, can be used.

The process 10 may include an optional transformation stage 110, with the line 38 then leading into the transformation stage 110, and an amorphous sugar withdrawal line 112 leading from the stage 110. In the transformation stage 110, the concentrated polished liquid sugar product from the polishing stage 36 is subjected to a shear force to induce catastrophic sugar nucleation, and the sugar product allowed to crystallize, thereby to form microcrystalline or amorphous sugar. This is typically effected by subjecting the concentrated polished liquid sugar, at a temperature of 115° C. to 135° C., to a shear force having a velocity gradient of at least 5000 cm/sec/cm, and discharging the resultant nucleated syrup on to a suitable collector, eg a belt conveyor.

The Applicant has unexpectedly found that, by means of the process according to the invention, a range of high quality sugars, both liquid and crystallized, can be obtained from clarified sugar cane juice. The liquid sugar products consist primarily of sucrose, fructose and glucose in any desired proportions, and it was unexpectedly found that such products can be produced in the process of the invention, without having to resort to crystallization, thereby resulting in a more cost effective process.

Furthermore, instead of relying only on a single de-ashing ion exchange stage to demineralize on clarified sugar cane juice, in the process of the invention demineralization or de-ashing is split between the primary ion exchange stage 18 and the secondary ion exchange stage 28. Splitting the de-ashing between the weak base anion exchange resins of the primary ion exchange stage 18 and the strong based anion exchange resins of the secondary ion exchange stage results in the following unexpected advantages:
part of the de-ashing and decolourization can be carried out using weak base anion resins which are cheaper and have longer life spans than strong base anion resins
it permits the use of two different regenerant chemicals namely ammonium hydroxide (for the weak base resin) and caustic (KOH) (for the strong base resin), which provides greater flexibility as regards the make up of a fertilizer composition when the spent regenerant chemicals are used for fertilizer applications.

The “off-set” exchanger configuration of the primary and secondary ion exchange stages 18 and 28 as herein before described (in contrast to known configurations where the juice simply passes sequentially from a cation exchange resin to an anion exchange resin), provides improved performance as regards product quality.

It was also unexpectedly found that chemical efficiency is maximized with the exchanger arrangements in the stages 18 and 28 in accordance with the invention, that is, as herein before described. Thus, to maximise chemical efficiency during regeneration, it is important to fully load the cation resin during adsorption. If a column of resin is to be fully loaded with ash before regeneration, minimal juice de-ashing will take place towards the end of the cycle (the only treatment step that will then take place is juice softening). It is for this reason that the juice passes through two consecutive cation exchangers 78 and 80 before contacting the anion resin in the exchanger 86.

This will ensure efficient operation of the exchanger 86 when targeting very high loading of the resins in the exchangers 78 and 80.

The kinetics of colour removal on a weak base anion resin, such as that in the exchanger 86, are significantly slower than the de-ashing kinetics. In addition, colour removal improves at high pH. The additional passage of the juice through the anion ion exchangers 94 and 98 gives enhanced colourization during de-ashing, thereby maximising the decolourization efficiency.

Finally, it is believed that the configurations of exchangers used in the ion exchange stages 18, 28 will provide enhanced operational stability and ease of control as compared to standard two or three pass de-ashing configurations.

1. A process for treating clarified sugar cane juice, which process includes
subjecting, in a first treatment stage, clarified sugar cane juice to purification to remove particles larger than about 0.1 micron;
passing the clarified sugar juice from the first treatment stage through a primary ion exchange stage in which the sugar juice is sequentially brought into contact with at least one strong acid cation ion exchange resin in the hydrogen form and thereafter with at least one weak base anion ion exchange resin in the hydroxide form, to effect primary demineralization of the sugar juice;
thereafter passing the sugar juice through a secondary ion exchange stage in which the sugar juice is sequentially brought into contact with at least one strong base anion ion exchange resin in the hydroxide form and thereafter with at least one acid cation ion exchange resin, to effect secondary demineralization of the sugar juice, thereby to obtain a purified sugar solution; and
recovering sugar products from the purified sugar solution.

2. A process according to claim 1, wherein the purification in the first treatment stage is effected by means of filtration by passing the clarified sugar juice through a membrane capable of removing particles larger than about 0.1 micron.

3. A process according to claim 2, wherein the membrane is in the size range 200 Angstrom to 0.1 micron so that the clarified sugar juice is subjected to ultrafiltration.

4. A process according to claim 1, which includes concentrating the clarified sugar juice to a sucrose concentration of at least 20% (m/m) before it enters the first treatment stage.

5. A process according to claim 1, wherein the treatment in the first treatment stage is effected at an elevated temperature of at least 90° C., with the process including cooling the juice to below 60° C. before it is subjected to ion exchange.

6. A process according to claim 5, wherein, in the primary ion exchange stage, the sugar juice is initially brought into contact sequentially with two of the strong acid cation ion exchange resins in the hydrogen form, which are thus arranged in series, and thereafter into contact with the weak base anion ion exchange resin in the hydroxide form.

7. A process according to claim 6, wherein the juice is thereafter, in the primary ion exchange stage, passed through a further strong acid cation ion exchange resin in the hydrogen form, and thereafter sequentially through two weak base anion ion exchange resins in the hydroxide form, which are thus also arranged in series.

8. A process according to claim 6, which includes, from time to time, regenerating the strong acid cation ion resins by contacting them with hydrochloric or nitric acid, with a spent acid stream rich in potassium salt thereby being obtained, and regenerating the anion resins by contacting them with an ammonium based alkali, with a spent alkali stream rich in nitrogen being obtained.

9. A process according to claim 5, wherein, in the secondary ion exchange stage, the sugar juice from the primary ion exchange stage is brought sequentially into contact with two of the strong base anion ion exchange resins in the hydroxide form, which are thus arranged in series, before being brought into contact with the cation ion exchange resin.

10. A process according to claim 5, wherein, in the secondary ion exchange stage, the sugar juice from the primary ion exchange stage is brought into contact with a first strong base anion ion exchange resin in hydroxide form, then into contact with the cation ion exchange resin, and thereafter into contact with a second strong base anion ion exchange resin in the hydroxide form.

11. A process according to claim 9, which also includes, from time to time, regenerating the strong base anion ion exchange resins by subjecting them to a two stage regeneration process comprising firstly regenerating them using brine at a temperature above 50° C., and thereafter regenerating them with sodium hydroxide at a temperature below 50° C., while the weak acid resin is regenerated by means of using a strong acid.

12. A process according to claim 5, wherein the recovery of the sugar products from the purified sugar solution emerging from the secondary ion exchange stage includes, in a concentration stage, concentrating the purified sugar solution, and treating the resultant concentrated sugar juice to recover therefrom at least one liquid sugar product and/or at least one solid or crystal sugar product.

13. A process according to claim 12, which includes adjusting the sugar composition of the concentrated sugar juice.

14. A process according to claim 13, which includes adjusting the sucrose/invert (fructose and glucose) ratio by adjusting the temperature at which the clarified sugar juice is subjected to ion exchange in the primary and secondary ion exchange stages.

15. A process according to claim 13, wherein, to enhance fructose and glucose production, the temperature is selected so that a high degree of inversion to fructose and glucose takes place in the primary and secondary ion exchange stages.

16. A process according to claim 15, wherein, to adjust the relative proportions of fructose and glucose independently, fully inverted concentrated sugar juice from the concentration stage is routed to a fructose/glucose chromatographic separation stage.

17. A process according to claim 13, wherein adjusting the sugar composition of the concentrated sugar juice includes subjecting the concentrated sugar juice to chromatography and/or isomerization, thereby to adjust or to vary the relative proportions of sucrose, fructose and glucose therein.

18. A process according to claim 12, wherein at least one liquid sugar product is produced, with the liquid sugar product being subjected to chromatography and/or isomerization, thereby to vary or to adjust the relative proportions of sucrose, fructose and glucose therein.

19. A process according to claim 12, wherein concentrated sugar juice from the concentration stage passes to a polishing stage to improve product quality further.

20. A process according to claim 12, which includes subjecting the liquid sugar product to transformation, to obtain therefrom microcrystalline or amorphous sugar.

21. A process according to claim 20, wherein the transformation of the liquid sugar product includes subjecting the liquid sugar product to a shear force to induce catastrophic sugar nucleation, and allowing the sugar product to crystallize, to form the microcrystalline or amorphous sugar.
